(19) United States
(12) Patent Application Publication
(10) Pub. No.: US 2007/0154628 A1
(43) Pub. Date: Jul. 5, 2007

(54) Solid polymer membrane fuel-cell manufacturing method

(75) Inventors: Akira Fujiki, Kanagawa (JP); Yukihiro Maekawa, Kanagawa (JP); Takeshi Shimizu, Boulogne Billancourt (FR); Takayuki Hirao, Kanagawa (JP); Masanori Iwamoto, Kanagawa (JP); Sadao Miki, Kanagawa (JP); Haruhiko Suzuki, Kanagawa (JP); Hiroshi Saitou, Kanagawa (JP)

Correspondence Address: FOLEY AND LARDNER LLP;SUITE 500, 3000 K STREET NW, WASHINGTON, DC, 20007, US

(73) Assignee: NISSAN MOTOR CO., LTD., YOKOHAMA-SHI, KANAGAWA JAPAN (JP)

(21) Appl. No.: 10/587,489

(22) PCT Filed: Dec. 28, 2004
(86) PCT No.: PCT/JP04/19845

§ 371 Date: Jul. 27, 2006

(51) Int. Cl. B05D 5/12; H01M 2/08

(52) U.S. Cl. 427/115; 429/35

(57) ABSTRACT

This invention relates to a manufacturing method for a polymer electrolyte fuel cell which is formed by laminating a first gas diffusion layer (6A) and a first separator (7A) on one surface of a membrane electrode assembly (9), and laminating a second gas diffusion layer (6B) and a second separator (7B) on the other surface of the membrane electrode assembly (9). An adhesive is applied to a surface of the first separator (7A) which contacts the first gas diffusion layer (6A), the adhesive is applied to a surface of the second separator (7B) which contacts the second gas diffusion layer (6B), and the first separator (7A), first gas diffusion layer (6A), membrane electrode assembly (9), second gas diffusion layer (6B), and second separator (7B) are disposed between a pair of pressing jigs (113, 123) so as to be laminated in the described sequence. An integrated fuel cell is obtained by applying heat and compression to the first separator (7A) and second separator (7B) using the pressing jigs (113, 123).

### TECHNICAL FIELD

This invention relates to a manufacturing method for a polymer electrolyte fuel cell.

### BACKGROUND ART

JP2001-236971A, published by the Japan Patent Office in 2001, discloses a manufacturing method for a polymer electrolyte fuel cell.

According to this manufacturing method, a catalyst is coated onto both surfaces of a polymer electrolyte membrane and then dried to form a membrane electrode assembly (MEA). Meanwhile, two gas diffusion layers (GDL) prepared in advance are coated with a polymer electrolyte solution and the membrane electrode assembly is sandwiched between the two GDLs such that the coated surfaces contact the MEA. The MEA and GDLs are then integrated using a hot roll. The resulting unit is referred to as a first unit.

Meanwhile, cell frames are adhered respectively to two separators and a hot roll is applied thereto to form two second units.

Finally, the first unit is sandwiched between the two second units and a hot roll is applied thereto to complete the polymer electrolyte fuel cell.

### DISCLOSURE OF THE INVENTION

According to the prior art, a process for obtaining the first unit by integrating the gas diffusion layers with the membrane electrode assembly and a process for obtaining the polymer electrolyte fuel cell by integrating the first unit and second units are performed sequentially, and hence the manufacturing process increases in length.

It is therefore an object of this invention to shorten the manufacturing process of a polymer electrolyte fuel cell.

To achieve the object described above, this invention provides a manufacturing method for a polymer electrolyte fuel cell formed by laminating a first gas diffusion layer and a first separator onto one surface of a polymer electrolyte membrane, and laminating a second gas diffusion layer and a second separator onto another surface of the polymer electrolyte membrane.

The manufacturing method comprises applying an adhesive to a surface of the first separator which contacts the first gas diffusion layer, applying the adhesive to a surface of the second separator which contacts the second gas diffusion layer, disposing the first separator, first gas diffusion layer, polymer electrolyte membrane, second gas diffusion layer, and second separator between a pair of pressing jigs so as to be laminated in the described sequence, and obtaining an integrated fuel cell by applying heat and compression to the first separator and second separator using the pressing jigs.

The details as well as other features and advantages of this invention are set forth in the remainder of the specification and are shown in the accompanying drawings.

### BRIEF DESCRIPTION OF THE DRAWINGS

FIG. 1 is a block diagram of a manufacturing device, illustrating a manufacturing process of a polymer electrolyte fuel cell according to this invention.

FIG. 2 is a schematic plan view of a supply mechanism, illustrating a supply structure for supplying a separator to the manufacturing device.

FIG. 3 is a block diagram of a manufacturing device, illustrating a hot press process according to this invention.

FIG. 4 is an exploded vertical sectional view of a polymer electrolyte fuel cell and a pressing jig.

FIG. 5 is similar to FIG. 4, but shows another embodiment of the pressing jig.

FIG. 6 is similar to FIG. 4, but shows a further embodiment of the pressing jig.

### BEST MODE FOR CARRYING OUT THE INVENTION

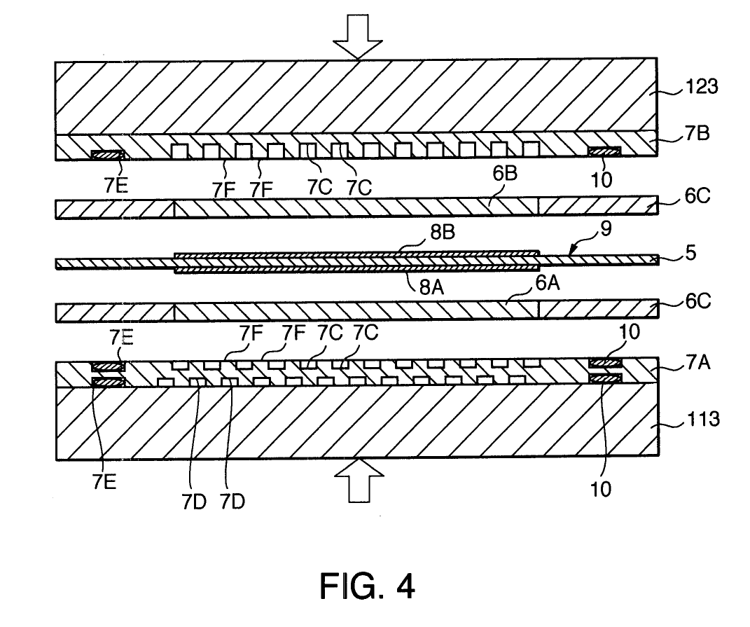

Referring to FIG. 4 of the drawings, a polymer electrolyte fuel cell is manufactured by integrating a membrane electrode assembly (MEA) 9, a first gas diffusion layer (GDL) 6A, a second gas diffusion layer (GDL) 6B, a first separator 7A, and a second separator 7B using a pair of pressing jigs 113 and 123. The MEA 9, the gas diffusion layers 6A, 6B, and the separators 7A, 7B all have a rectangular planar form.

The MEA 9 is manufactured by forming a first catalyst layer 8A and a second catalyst layer 8B at fixed intervals on the respective surfaces of a polymer electrolyte membrane 5 made of a perfluoroethylene sulfonic acid resin. The catalyst layers 8A, 8B are formed by coating the polymer electrolyte membrane 5 in advance with a polymer electrolyte liquid containing platinum as a catalyst.

One of the catalyst layers 8A, 8B constitutes an anode of the fuel cell while the other constitutes a cathode of the fuel cell. The first catalyst layer 8A, first GDL 6A, and first separator 7A are disposed below the polymer electrolyte membrane 5 while the second catalyst layer 8B, second GDL 6B, and second separator 7B are disposed above the polymer electrolyte membrane 5. The pressing jig 113 contacts the first separator 7A from below, while the pressing jig 123 contacts the second separator 7B from above.

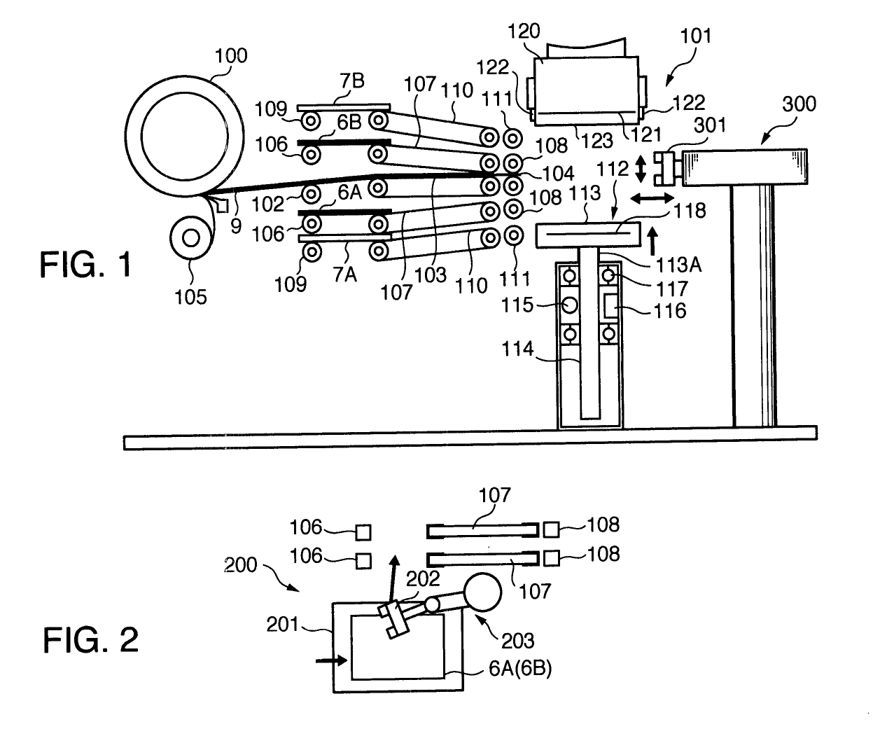

As shown in FIG. 1, the MEA 9 is supplied in the form of a roll 100. To protect the catalyst layers 8A, 8B, the MEA 9 is wound into a roll with a protective film covering its surface.

The GDLs 6A, 6B are formed by subjecting carbon cloth or carbon paper to water repellency processing, and serve to transmit and diffuse anode gas and cathode gas supplied from the separators 7A, 7B toward the catalyst layers 8A, 8B. Each GDL 6A, 6B is supplied after being mounted in advance in a frame 6C constituted by an electric insulation material.

The first separator 7A comprises groove form gas passages 7C in a surface thereof facing the first GDL 6A. To prevent gas leakage from the gas passages 7C, a sealing groove 7E filled with a sealing gasket 10 is formed around the outer periphery of the first separator 7A. Groove form cooling liquid passages 7D and the sealing groove 7E filled with the sealing gasket 10 are also formed in the other surface of the first separator 7A.

The second separator 7B comprises the groove form gas passages 7C in a surface thereof facing the second GDL 6B. To prevent gas leakage from the gas passages 7C, the sealing groove 7E filled with the sealing gasket 10 is formed around the outer periphery of the second separator 7B. The other surface of the second separator 7B is formed flat.

Depending on the specifications of the fuel cell to be manufactured, the cooling liquid passages 7D in the first separator 7A need not always be formed. When the cooling liquid passages 7D are not provided, the first separator 7A and second separator 7B can be formed to identical specifications. Depending on the specifications of the fuel cell, gas passages for an adjacent fuel cell may be formed instead of the cooling liquid passages 7D.

The separators 7A, 7B are formed by mixing together graphite powder and plastic powder and subjecting the mixture to compression molding using a hot press process employing a die. Alternatively, the separators 7A, 7B may be formed by subjecting expanded graphite sheet to press molding. The separators 7A, 7B may also be formed using metal.

The desired characteristics of the separators 7A, 7B are low electric resistance and low gas permeability. Excellent mechanical strength is also desirable so that the thickness of the separators 7A, 7B can be reduced. Metallic separators are capable of satisfying these requirements, but since the separators 7A, 7B are exposed to both an oxidizing atmosphere and a reducing atmosphere, a corrosion resistant metal or a material that has been subjected to surface processing through metal plating is preferably used.

Referring to FIG. 1, in this invention the MEA 9, GDLs 6A, 6B, and separators 7A, 7B, constituted as described above, are assembled using a pressing machine 101 comprising the pressing jigs 113 and 123.

The MEA 9 is fed from the roll 100 in a substantially horizontal direction toward the pressing machine 101 by a conveyance mechanism constituted by a conveyance roller 102, a belt conveyor 103, and a discharge roller 104. Preferably, conveyance holes are formed at fixed intervals in the two side portions of the MEA 9 and projections which engage with the conveyance holes are formed at equal angular intervals on the conveyance roller 102 and discharge roller 104. By means of this constitution, looseness in the MEA 9 during conveyance thereof can be prevented, and the MEA 9 can be supplied to the pressing machine 101 with precision in fixed lengths corresponding to the formation intervals of the catalyst layers 8. It is also preferable that marks corresponding to the position of the catalyst layers 8A, 8B be formed on the MEA 9, and that a sensor for reading the marks be disposed on the pressing machine 101. By feeding the MEA 9 on the basis of the marks read by the sensor, the catalyst layers 8A, 8B can be positioned accurately in a predetermined operation position within the pressing machine 101.

The protective film covering the surface of the MEA 9 is wound up by a protective film wind-up roller 105 when the MEA 9 is fed from the roll 100.

The first GDL 6A is supplied to the pressing machine 101 from the lower side of the MEA 9 by a conveyance mechanism constituted by a conveyance roller 106, a belt conveyor 107, and a discharge roller 108. The second GDL 6B is supplied to the pressing machine 101 from the upper side of the MEA 9 by an identically constituted conveyance mechanism.

The initial conveyance positions of the first GDL 6A and second GDL 6B are positions straddling the respective conveyance rollers 106 and belt conveyors 107. The GDLs 6A, 6B are carried to these initial positions by a supply mechanism 200 shown in FIG. 2.

Referring to FIG. 2, the supply mechanism 200 is disposed to the side of the conveyance roller 106 and belt conveyor 107. The supply mechanism 200 comprises a carrying stage 201 and a robot 203. The robot 203 comprises a pivoting robot arm 202. The GDL 6A, 6B carried on the carrying stage 201 is grasped by the pivoting robot arm 202 and set in the initial position. The robot 203 is structured to be capable of setting the GDL 6A, 6B of the MEA 9 in both the initial position of the first GDL 6A and the initial position of the second GDL 6B.

Returning to FIG. 1, the first separator 7A is fed toward the pressing machine 101 by a conveyance mechanism constituted by a conveyance roller 109, a belt conveyor 110, and a discharge roller 111. The second separator 7B is fed toward the pressing machine 101 by a separate conveyance mechanism having an identical constitution.

The conveyance mechanism for the first separator 7A is disposed below the conveyance mechanism for the first GDL 6A. The conveyance mechanism for the second separator 7B is disposed above the conveyance mechanism for the second GDL 6B.

The initial conveyance positions of the first separator 7A and second separator 7B are positions straddling the respective conveyance rollers 109 and belt conveyors 110. The separators 7A, 7B are carried to these initial positions by a supply mechanism constituted similarly to the supply mechanism for the GDLs 6A, 6B. The supply mechanism for the separators 7A, 7B is preferably disposed on the opposite side of the conveyance mechanism to the supply mechanism for the GDLs 6A, 6B to prevent interference with the supply mechanism for the GDLs 6A, 6B.

By means of the constitutions described above, the first separator 7A, the first GDL 6A, the MEA 9, the second GDL 6B, and the second separator 7B are supplied in that order to the pressing machine 101.

The pressing machine 101 is constituted by an elevating table 112 and a support 120 fixed thereabove.

The elevating table 112 comprises the pressing jig 113, which carries the first separator 7A, first GDL 6A, MEA 9, second GDL 6B, and second separator 7B, and a vertical shaft 113A which supports the pressing jig 113. A rack 114 is formed in the shaft 113A. The elevating table 112 further comprises a pinion 115 which meshes with the rack 114, a servo motor 116 which drives the pinion 115 to rotate, and a bearing 117 which guides the vertical motion of the shaft 113A. A heater 118 is installed inside the pressing jig 113.

The support 120 comprises the pressing jig 123 which supports the constitutional members of the fuel cell, which have been raised by the elevating table 112, in a downward-facing manner. A heater 121 is buried within the pressing jig 123. A pair of cutters 122 for cutting the MEA 9 are attached to the front surface and rear surface of the support 120 in the conveyance direction of the MEA 9.

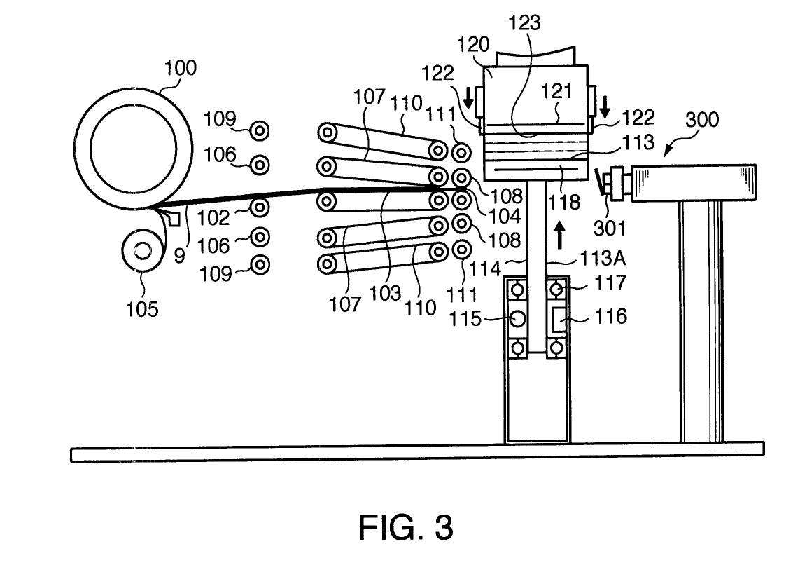

Next, referring to FIG. 3, a hot press process performed by the pressing machine 101 will be described.

An adhesive containing a phenol or epoxy thermosetting resin is applied in advance to restricted predetermined positions on the respective surfaces of the two GDLs 6A and 6B facing the MEA 9. The adhesive is applied either in the supply mechanism 200 or during conveyance of the GDLs 6A, 6B by the conveyance mechanism.

The adhesive is applied to the lower surface of the second GDL 6B, and hence the adhesive application position is set so as not to interfere with the conveyance roller 102, belt conveyor 103, and discharge roller 104.

An adhesive containing a phenol or epoxy thermosetting resin is applied in advance to the respective surfaces of the two separators 7A, 7B facing the GDLs 6A, 6B. More specifically, the adhesive is applied to partition wall portions 7F positioned between the gas passages 7C of the separators 7A, 7B in FIG. 3. The adhesive is applied either in the supply mechanism for the separators 7A, 7B or during conveyance of the separators 7A, 7B by the conveyance mechanism. The adhesive is applied to the lower surface of the separator 7B, and hence the adhesive application position is set so as not to interfere with the conveyance roller 109, belt conveyor 110, and discharge roller 111.

In the hot press process, pressing is performed while heating the MEA 9, GDLs 6A, 6B and separators 7A, 7B such that these members are integrated by thermal compression or thermal adhesion.

After the respective conveyance mechanisms have laminated the first separator 7A, first GDL 6A, MEA 9, second GDL 6B, and second separator 7B on the pressing jig 113 in that order, the pressing machine 101 drives the pinion 115 to rotate by driving the servo motor 116 such that the pressing jig 113 is pushed upward toward the support 120 via the rack 114 and shaft 113A, as shown in FIG. 3.

Referring to FIG. 4, by raising the pressing jig 113, the second separator 7B positioned on the uppermost layer of the laminated body comes into contact with the pressing jig 123 of the support 120. The pressing jig 123 and the pressing jig 113 are heated in advance to a range of 80 to 150 degrees centigrade by the heater 121 and the heater 118, respectively. It should be noted that in the figure, the MEA 9, GDLs 6A, 6B, and separators 7A, 7B are separated from each other for illustrative purposes, but in actuality, these members rise in laminated form when the pressing jig 113 is raised.

After the second separator 7B has come into contact with the pressing jig 123, the pressing jig 113 applies predetermined pressure and heat from a vertical direction to the MEA 9, GDLs 6A, 6B, and separators 7A, 7B laminated between the pressing jig 113 and the pressing jig 123. As a result, the adhesive applied to the GDLs 6A, 6B is thermally adhered to the MEA 9. More specifically, the thermosetting agent contained in the adhesive is hardened by the heat so that the MEA 9 and GDLs 6A, 6B are adhered to each other securely.

As noted above, the adhesive is applied only to restricted locations rather than the entire surfaces of the GDLs 6A, 6B. Hence, in the finished fuel cell, gas diffusion and transmission from the GDLs 6A, 6B to the catalyst layers 8A, 8B is performed unhindered by the adhesive. The polymer electrolyte constituting the catalyst layers 8A, 8B is thermally compressed onto the GDLs 6A, 6B even in the surface locations that are not coated with the adhesive, and by means of an anchor effect, the GDLs 6A, 6B and catalyst layers 8A, 8B are attached to each other tightly without gaps.

Similarly, when the thermosetting agent contained in the adhesive that is applied to the partition wall portions 7F of the separators 7A, 7B hardens, the separators 7A, 7B and GDLs 6A, 6B are adhered to each other securely.

Thus, the laminated body constituted by the sequentially laminated first separator 7A, first GDL 6A, MEA 9, second GDL 6B, and second separator 7A is integrated in a single hot press process, and as a result the fuel cell is completed within a short time period.

The fuel cell integrated in the pressing machine 101 is conveyed to a collection location by a robot 300 comprising a robot arm 301 shown in FIGS. 1 and 3.

Thereafter, supply of the separator 7A, GDL 6A, MEA 9, GDL 6B, and separator 7B to the pressing machine 101 by the respective supply mechanisms and conveyance mechanisms, integration of these members by the pressing machine 101, and conveyance of the integrated fuel cell to the collection location by the robot 300 are repeated.

As described above, in this invention the separator 7A, GDL 6A, MEA 9, GDL 6B, and separator 7B are integrated in a single hot press process, and hence the manufacturing process for the polymer electrolyte fuel cell can be shortened.

The embodiment described above employs the MEA 9, which is constituted by the catalyst layers 8A, 8B coated onto the two surfaces of the polymer electrolyte membrane 5 at fixed intervals, but the catalyst layers 8A, 8B may be formed on the respective surfaces of the GDLs 6A, 6B. In this case, the conveyance mechanism constituted by the conveyance roller 102, belt conveyor 103, and discharge roller 104 supplies the polymer electrolyte membrane 5 alone to the pressing machine 101. On the other hand, the supply mechanism 200 for the GDLs 6A, 6B supplies the GDLs 6A, 6B to their initial conveyance positions after the catalyst layers 8A, 8B have been applied to the surfaces of the GDLs 6A, 6B facing the polymer electrolyte membrane 5. In this case, the catalyst layers 8A, 8B are thermally compressed onto the polymer electrolyte membrane 5 by means of hot pressing in the pressing machine 101. The catalyst layers 8A, 8B may also be applied to predetermined positions on the polymer electrolyte membrane 5 during conveyance of the polymer electrolyte membrane 5.

The focus of the fuel cell manufacturing method according to this invention is the hot press process performed by the pressing machine 101, and therefore any methods may be used to supply the members to the pressing machine 101 and convey the integrated fuel cell.

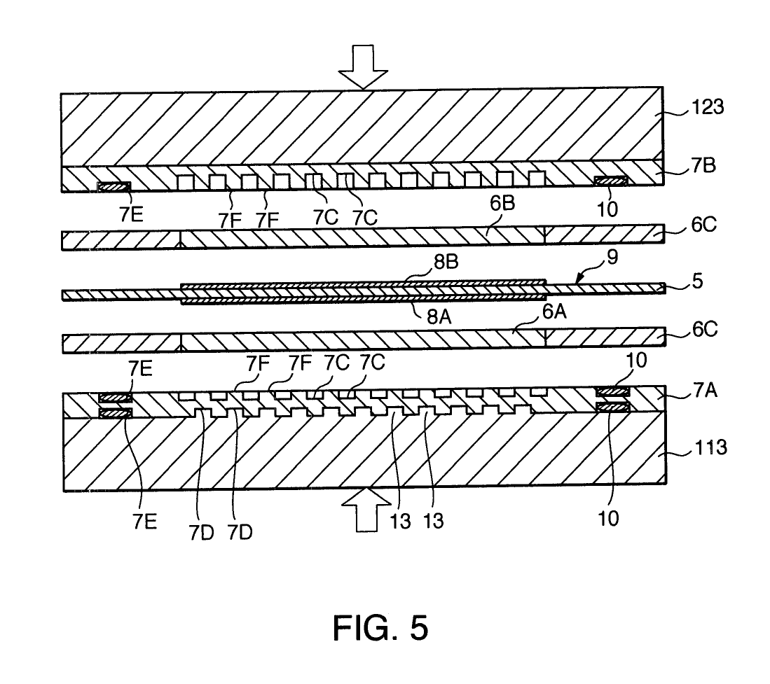

Next, referring to FIG. 5, a second embodiment of this invention relating to the shape of the pressing jig 113 in the pressing machine 101 will be described.

A feature of this embodiment is the shape of the upper surface of the pressing jig 113. Here, upward-facing strip form projections 13 which fit into the groove-form cooling liquid passages 7D formed in the first separator 7A are provided instead of forming the upper surface of the pressing jig 113 flat. By forming these strip form projections 13 in the pressing jig 113, positioning of the separator 7A is performed accurately. Further, when the separator 7A is formed from graphite, it is difficult for the pressing machine 101 to apply a sufficient compressive force to the laminated body due to the brittleness of the graphite. By fitting the strip form projections 13 of the pressing jig 113 into the groove form cooling passages 7D of the separator 7A as in this embodiment, a sufficient compressive force can be applied to the laminated body while avoiding stress concentration.

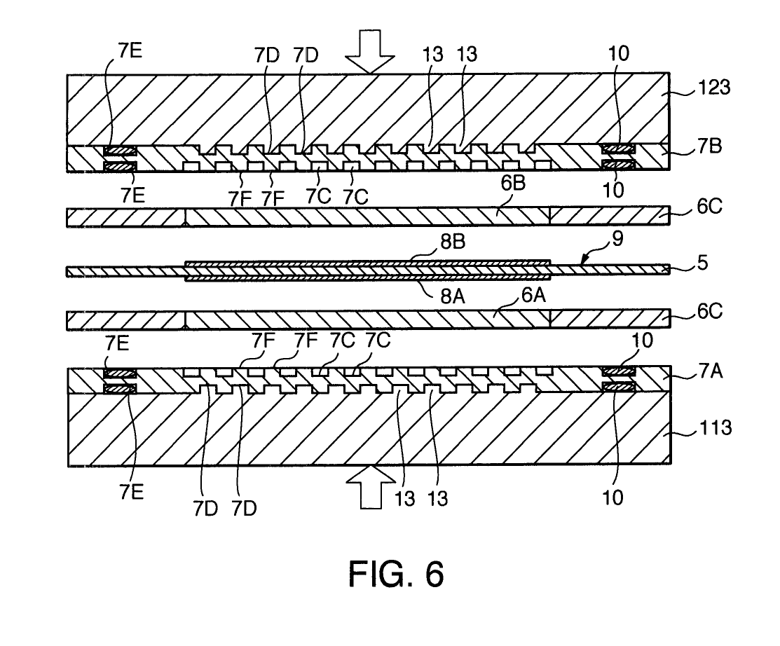

Next, referring to FIG. 6, a third embodiment of this invention relating to the shape of the pressing jig 123 in the pressing machine 101 will be described.

In this embodiment, the cooling liquid passages 7D are also formed on the rear surface of the second separator 7B, and the strip form projections 13 of the second embodiment are formed on both the upper surface of the pressing jig 113 and the lower surface of the pressing jig 123.

According to this embodiment, the separators 7A and 7B contact the pressing jig 113 and pressing jig 123 respectively with no gaps, and hence the support structure of the separators 7A and 7B during the hot press process achieves a further level of stability.

It should be noted that the second and third embodiments can also be applied to separators formed with gas passages instead of the cooling liquid passages 7D.

The contents of Tokugan 2004-019743, with a filing date of Jan. 28, 2004 in Japan, are hereby incorporated by reference.

Although the invention has been described above by reference to certain embodiments of the invention, the invention is not limited to the embodiments described above. Modifications and variations of the embodiments described above will occur to those skilled in the art, within the scope of the claims.

### INDUSTRIAL APPLICABILITY

According to this invention, laminated constitutional members of a fuel cell can be integrated through a single hot press process. As a result, a manufacturing process for a polymer electrolyte fuel cell unit can be shortened, and a particularly favorable effect can be obtained by incorporating this invention into a manufacturing process for a fuel cell stack using a large number of fuel cells.

The embodiments of this invention in which an exclusive property or privilege is claimed are defined as follows:

1-7. (canceled)

8. A manufacturing method for a polymer electrolyte fuel cell, the fuel cell comprising a polymer electrolyte membrane, a first gas diffusion layer and a first separator laminated on one surface of the polymer electrolyte membrane, and a second gas diffusion layer and a second separator laminated onto another surface of the polymer electrolyte membrane, the method comprising:
applying an adhesive to a surface of the first separator which contacts the first gas diffusion layer;
applying the adhesive to a surface of the second separator which contacts the second gas diffusion layer;
disposing the first separator, the first gas diffusion layer, the polymer electrolyte membrane, the second gas diffusion layer, and the second separator between a pair of pressing jigs so as to be laminated in the described sequence; and
obtaining an integrated fuel cell by applying heat and pressure to the first separator and the second separator using the pressing jigs.

9. The manufacturing method as defined in claim 8, wherein the first separator comprises a groove form gas passage facing the first gas diffusion layer, the adhesive applied to the first separator is applied to a partition wall portion defining the gas passage, the second separator comprises the groove form gas passage facing the second gas diffusion layer, and the adhesive applied to the second separator is applied to the partition wall portion defining the gas passage.

10. The manufacturing method as defined in claim 8, wherein a first catalyst layer and a second catalyst layer are coated onto the respective surfaces of the polymer electrolyte membrane in advance, and as a result of the pressure and heat applied to the first separator and the second separator by the pressing jigs, the first gas diffusion layer is thermally adhered to the first catalyst layer and the second gas diffusion layer is thermally adhered to the second catalyst layer.

11. The manufacturing method as defined in claim 10, wherein an adhesive is applied to only certain locations of the first gas diffusion layer facing the first catalyst layer, an adhesive is applied to only certain locations of the second gas diffusion layer facing the second catalyst layer, and as a result of the pressure and heat applied to the first separator and the second separator by the pressing jigs, the first gas diffusion layer is thermally adhered to the first catalyst layer and the second gas diffusion layer is thermally adhered to the second catalyst layer.

12. The manufacturing method as defined in claim 8, wherein the adhesive includes a thermosetting resin.

13. The manufacturing method as defined in claim 8, wherein the first separator comprises a concave portion in a surface facing the pressing jig, and the pressing jig comprises a convex portion which fits into the concave portion in the first separator.

14. The manufacturing method as defined in claim 13, wherein the concave portion is a cooling liquid passage of the fuel cell.
